(19) United States
(12) Patent Application Publication
(10) Pub. No.: US 2023/0327284 A1
(43) Pub. Date: Oct. 12, 2023

(54) BATTERY MODULE

(71) Applicant: JAGUAR LAND ROVER LIMITED, Whitley, Coventry, Warwickshire (GB)

(72) Inventor: Chris GODDING, Whitley, Coventry, Warwickshire (GB)

(21) Appl. No.: 18/042,960

(22) PCT Filed: Aug. 23, 2021
(86) PCT No.: PCT/EP2021/073266

§ 371 Date: Feb. 24, 2023

(30) Foreign Application Priority Data
Aug. 27, 2020 (GB) 2013461.5

(51) Int. Cl. H01M 50/30; H01M 50/213; H01M 50/342; H01M 10/613; H01M 10/625; H01M 10/643; H01M 10/6554; H01M 50/505; H01M 50/588; H01M 50/593

(52) U.S. Cl. CPC H01M 50/394; H01M 50/213; H01M 50/3425; H01M 10/613; H01M 10/625; H01M 10/643; H01M 10/6554; H01M 50/505; H01M 50/588; H01M 50/593; B60L 50/64

(57) ABSTRACT

Embodiments include vehicles and battery modules in which a vent volume is provided within a battery module housing. Such a vent volume allows gases expelled from a venting cell to be directed away from the other cells in the module, thereby reducing a likelihood that a venting event in one of the cells will lead to a cascade of venting events in other cells.

### TECHNICAL FIELD

Aspects of the invention relate to a battery module and to a vehicle, particularly, but not exclusively to an electric or hybrid electric vehicle and battery modules therefor.

### BACKGROUND

There has recently been increased interest in providing battery-powered vehicles, which has led to developments in vehicle battery, in particular vehicle traction battery, technology. It is generally desirable for vehicle batteries to provide high energy capacity and peak current output, whilst minimising the size and weight of the battery module and thus the vehicle. However, these requirements must be balanced against a need for the battery to be capable of being adequately cooled, since the cells that are typically used in vehicle traction batteries can degrade relatively quickly, or become damaged, if their temperature is permitted to exceed a certain limit repeatedly.

Furthermore, it is also important to ensure that vehicle safety is not compromised in the event of a vehicle battery being damaged. Indeed, some regulatory tests require that batteries used in automotive vehicles must not cause an uncontrolled exothermal reaction affecting all of the cells after damage to one cell within a battery module, or at least that any such reaction is sufficiently slow to allow the vehicle occupants time to escape the vehicle.

As such, it is desirable to provide vehicle battery modules capable of providing improved energy and/or current density, whilst maintaining adequate cooling performance and avoiding the possibility of thermal runaway.

It is an object of embodiments of the invention to at least mitigate one or more of the problems of the prior art.

### SUMMARY OF THE INVENTION

According to an aspect of the invention for which protection is sought, there is provided a battery module comprising: a housing; a plurality of cylindrical cells, each of the cells having a first end and a second end, wherein at least one vent means is located at the first end of each of the cells; and separation structure; wherein: the plurality of cells are disposed within the housing in a common orientation such that the first ends of each of the cells are substantially coplanar; the separation structure is arranged within the housing proximate to the first ends of the plurality of cells and is arranged to allow gases expelled from a venting cell to pass through the separation structure; and the housing comprises a vent volume arranged between the separation structure and an inner surface of the housing for allowing venting from the vent means of each of the plurality of cells into the vent volume via the separation structure. Advantageously, the vent volume allows vent gases that are ejected from a cell to expand and cool, without causing excessive heating of other cells within the battery module. This helps to mitigate the risk of a malfunction in a single cell causing a cascade of thermal runaway reactions.

Optionally each of the cylindrical cells circumferentially abuts at least one other cylindrical cell, preferably at least two other cylindrical cells. This may help to slow down any exothermal reactions that take place within a malfunctioning cell, as the adjacent cells may act as heat sinks to help to cool the cell.

Within the scope of the present application cells may be considered to be abutting one another if they are directly in contact, or if they are joined together via a layer of adhesive. In some embodiments, the layer of adhesive may have a thickness of 0.5 mm or less, preferably 0.3 mm or less. Advantageously, the adhesive may be thermally conductive. As will become apparent from the following disclosure, the present inventors have recognised that placing cells in thermal contact with one another helps to reduce the incidence and/or severity of cell malfunctions.

In an embodiment, the battery module further comprises a busbar arranged at the first end of the plurality of cells. Optionally, the busbar is located between the first ends of the cells and the separation structure.

In an embodiment, the separation structure comprises a support component having a plurality of apertures formed therein and a protective layer covering each of the apertures, the protective layer being arranged to break when a predetermined pressure differential exists across the protective layer. Advantageously, such a protective layer may help to mitigate against the risk of vent gases ejected from a cell entering the space between cells. Optionally, the protective layer comprises a coating applied to the first end surface of each cell.

In an embodiment, the protective layer comprises a sheet of insulating material. The sheet of insulating material is preferably non-combustible. In an embodiment, a non-solid compound is provided in a space between the first ends of at least some of the cells and the sheet of insulating material. Preferably, the non-solid compound is provided in substantially all of the spaces between the first ends of the cells and the insulating layer. The non-solid compound may be a non-curing silicone-based compound and/or a non-solid intumescent compound. Advantageously, provision of such a compound may help to prevent hot gases in the vent volume from entering the spaces between the cells, thereby helping to reduce the likelihood that venting events in one or more cells will initiate a cascade of further venting events.

In an embodiment, the separation structure comprises a first filter layer. Such a filter layer may help to reduce the amount of vent gas that is allowed to enter the space between cells from the vent volume, as the pressure in the vent volume may be relatively low, and insufficient to cause vent gases within the vent volume to traverse the filter layer. However, vent gases exiting a cell typically do so at relatively high velocity, such that they traverse the filter layer relatively easily. The filter layer may also have significant thermal mass, so the vent gases may be cooled as they pass through the filter layer. Optionally, the first filter layer comprises a mesh. Further optionally, the mesh is at least partly formed from metal.

In an embodiment the first filter layer is arranged to: allow venting from the vent means of each of the plurality of cells into the vent volume; and substantially prevent material vented from the vent means of one of the plurality of cells to traverse the first filter layer from the vent volume to another of the plurality of cells.

In an embodiment, the battery module further comprises a second filter layer adjacent to the first filter layer. The second filter layer may include a phase change material. Such a phase change material may help to further cool the vent gases, by undergoing a phase change when vent gases pass through the second filter layer. As will be understood by the skilled person, such a phase change reduces the average temperature of the system, as the temperature of the phase change material does not increase during the phase change.

In an embodiment, the first filter layer includes a phase change material.

Optionally, the housing further comprises an exhaust port configured to allow fluid in the vent volume to exit the housing. Such an exhaust port may be positioned at a convenient location to ensure that vent gases exiting the battery module do not have a significant adverse effect on other vehicle systems or vehicle users. However, it will be understood that the vent gases exiting the housing will have cooled significantly since exiting the cell.

In an embodiment, the venting volume is a void.

In an embodiment, the battery module further comprises a cooling plate arranged to be thermally coupled to the second end of each of the plurality of cells. Advantageously, cooling the second ends of the cells can obviate the need to provide cooling means in a space between the cylindrical surfaces of the cells. This may allow the cells to be packed in to a given volume more efficiently.

Optionally, the vent volume has a depth of 1-20 mm, preferably 1-12 mm, more preferably 3-10 mm, most preferably 4-8 mm. In a particular embodiment, the vent volume has a depth of 6.6 mm. Advantageously, such a depth provides adequate volume for the vent gases to expand and cool, whilst making efficient use of the available space.

Alternatively, the depth of the vent volume may be defined in terms of a fraction of the individual cell diameter, for example the depth of the vent volume may be between 1/10-1/1 of the cell diameter, preferably ⅙-¾ of the cell diameter and more preferably ⅕-½ of the cylindrical cell diameter.

In an embodiment, the housing comprises a bash plate arranged to form an exterior of the battery module, wherein the inner surface of the housing is at least partly formed by the bash plate and wherein the bash plate is arranged to form an underside of the battery module housing. Advantageously, such a bash plate may be cooled by air passing underneath the vehicle.

According to another aspect of the invention for which protection is sought, there is provided a vehicle comprising a battery module as described above. In an embodiment, the second ends of the cells are above the first ends of the cells when the vehicle is in use travelling on a substantially level substrate.

According to another aspect of the invention for which protection is sought, there is provided a vehicle comprising a battery module, the battery module comprising a housing and a plurality of cylindrical cells, each of the cells having a first end and a second end, wherein vent means is located at the first end of each of the cells, wherein the plurality of cells are disposed within the housing in a common orientation such that the first ends of each of the cells are substantially coplanar and the second ends of the cells are above the first ends of the cells, and wherein the housing comprises a vent volume arranged between the first ends of the cells and an inner surface of the housing for allowing venting from the vent means of each of the plurality of cells into the vent volume. Advantageously, this arrangement ensures that any vent gases ejected from the cells are directed downwards. As will be well understood by the skilled person, battery modules are often located underneath a vehicle body. As such, this aspect ensures that vent gases are directed away from any vehicle occupants or cargo.

It will be understood that the statement that the second ends are above the first ends refers to the vehicle in normal use travelling on a substantially level substrate. For example, in the case of a land vehicle having one or more wheels or other ground-engaging parts, the orientation of the cells referred to above is the orientation when the wheels or other ground-engaging parts are on substantially level ground. Furthermore, although it is preferred that the longitudinal axes of the cells is substantially vertical when the vehicle is in normal use travelling on a substantially level substrate, it is within the scope of the present aspect of the invention for the longitudinal axes to be inclined relative to a vertical axis, provided the cells are oriented such that the second end of each cell within the plurality of cells is located above the first end of the respective cell.

In an embodiment, each of the cylindrical cells abuts at least one other cylindrical cell, preferably at least two other cylindrical cells. This may help to slow down any exothermal reactions that take place within a malfunctioning cell, as the adjacent cells may act as heat sinks to help to cool the cell.

Within the scope of the present application cells may be considered to be abutting one another if they are directly in contact, or if they are joined together via a layer of adhesive. In some embodiments, the layer of adhesive may have a thickness of 0.5 mm or less, preferably 0.3 mm or less.

In an embodiment, the housing comprises an exhaust port configured to allow egress of fluid from the housing. Such an exhaust port may be positioned at a convenient location to ensure that vent gases exiting the battery module do not have a significant adverse effect on other vehicle systems or vehicle users. However, it will be understood that the vent gases exiting the housing will have cooled significantly since exiting the cell.

Optionally, the housing comprises a bash plate arranged to form an exterior of the battery module, wherein the inner surface of the housing is at least partly formed by the bash plate and wherein the bash plate is arranged to form an underside of the battery module housing. Advantageously, such a bash plate may be cooled by air passing underneath the vehicle.

In an embodiment the venting volume is a void.

Optionally, the vent volume has a depth of 1-20 mm, preferably 1-12 mm, more preferably 3-10 mm, most preferably 4-8 mm. In a particular embodiment, the vent volume has a depth of 6.6 mm. Advantageously, such a depth provides adequate volume for the vent gases to expand and cool, whilst making efficient use of the available space.

Alternatively, the depth of the vent volume may be defined in terms of a fraction of the individual cell diameter, for example the depth of the vent volume may be between 1/10-1/1 of the cell diameter, preferably ⅙-¾ of the cell diameter and more preferably ⅕-½ of the cylindrical cell diameter.

In an embodiment, the vehicle further comprises a busbar disposed proximate to the first ends of the cells and electrically connected to the first ends of the cells.

In an embodiment a cooling plate is located proximate to the second ends of the cells. The cooling plate may be arranged to be thermally coupled to the second end of each of the plurality of cells. Advantageously, cooling the second ends of the cells can obviate the need to provide cooling means in a space between the cylindrical surfaces of the cells. This may allow the cells to be packed in to a given volume more efficiently.

In an embodiment, the vehicle further comprises a body, wherein the battery module is disposed beneath the body in use. Within the scope of the present application, the vehicle body refers to at least one of an occupant compartment, a luggage or cargo compartment and/or a pick-up bed.

In an embodiment, the battery module further comprises a separation structure, wherein the separation structure is arranged within the housing proximate to the first ends of the plurality of cells and is arranged to allow gases expelled from a venting cell to pass through the separation structure into the vent volume.

According to another aspect of the invention for which protection is sought, there is provided a vehicle comprising a battery module, the battery module comprising a housing and a plurality of cylindrical cells, each of the cells having a first end and a second end, wherein a vent feature and a first terminal of each of the cells is located at the first end of each cell, wherein the plurality of cells are disposed within the housing in a common orientation such that the first ends are substantially coplanar and the second ends are above the first ends, and wherein a cooling plate arranged to cool the cells is located proximate to the second ends of the cells. Advantageously, cooling of the second ends of the cells obviates the need for cooling means to be disposed in the space between the cylindrical surfaces of the cells, thereby allowing the cells to be packaged with greater efficiency in a given volume. Furthermore, the arrangement with the first ends of the cells underneath the second ends ensures that any vent gases ejected from the cells are directed downwards. As will be well understood by the skilled person, battery modules are often located underneath a vehicle body. As such, this aspect ensures that vent gases are directed away from the vehicle, its occupants, or cargo.

It will be understood that the statement that the second ends are above the first ends refers to the vehicle in normal use travelling on a substantially level substrate. For example, in the case of a land vehicle having one or more wheels or other ground-engaging parts, the orientation of the cells referred to above is the orientation when the wheels or other ground-engaging parts are on substantially level ground.

Furthermore, although it is preferred that the longitudinal axes of the cells is substantially vertical when the vehicle is in normal use travelling on a substantially level substrate, it is within the scope of the present aspect of the invention for the longitudinal axes to be inclined relative to a vertical axis, provided the cells are oriented such that the second end of each cell within the plurality of cells is located above the first end of the respective cell. It will be understood that the term “proximate” does not exclude the possibility of an intermediate layer being present between and cells and the cooling plate. Instead, the term “proximate to the second ends of the cells” should be taken to mean that the cooling plate is in abutment with or in thermally conductive contact with the cells.

In an embodiment, the second ends of the cells are in contact with the cooling plate via a thermal interface material. Such a thermal interface material may provide a more efficient thermally conductive contact than a direct contact with no interface material. In an embodiment, the thermal interface material may also act as an adhesive, thereby helping to support the weight of the cells.

Optionally, the adhesive thermal interface material attaches the cells to the cooling plate.

In an embodiment, each of the cylindrical cells circumferentially abuts at least one other cylindrical cell, preferably at least two other cylindrical cells. This may help to slow down any exothermal reactions that take place within a malfunctioning cell, as the adjacent cells may act as heat sinks to help to cool the cell.

In an embodiment, the vehicle further comprises a busbar disposed proximate to the first ends of the cells and electrically connected to the first ends of the cells.

In an embodiment, the housing comprises a vent volume arranged between the first ends of the cells and an inner surface of the housing for allowing venting from the vent means of each of the plurality of cells into the vent volume.

Optionally, the battery module further comprises a separation structure, wherein the separation structure is arranged within the housing proximate to the first ends of the plurality of cells and is arranged to allow gases expelled from a venting cell to pass through the separation structure into the vent volume.

Optionally, the vent volume has a depth of 1-20 mm, preferably 1-12 mm, more preferably 3-10 mm, most preferably 4-8 mm. In a particular embodiment, the vent volume has a depth of 6.6 mm. Advantageously, such a depth provides adequate volume for the vent gases to expand and cool, whilst making efficient use of the available space.

Alternatively, the depth of the vent volume may be defined in terms of a fraction of the individual cell diameter, for example the depth of the vent volume may be between 1/10-1/1 of the cell diameter, preferably ⅙-¾ of the cell diameter and more preferably ⅕-½ of the cylindrical cell diameter.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only, with reference to the accompanying figures, in which:

FIGS. 1A-C show different views of a cylindrical cell that may be used in a vehicle battery module (PRIOR ART);

FIG. 2 shows an example configuration of cylindrical cells within a battery module (PRIOR ART);

FIG. 3 shows a cross sectional view through a battery module in an embodiment of the present invention;

FIG. 4 shows an exploded view of the battery module shown in FIG. 3;

FIG. 5 shows a cross sectional view through a battery module in another embodiment of the present invention;

FIGS. 6A & 6B show two examples of vehicles according to an embodiment of the present invention; and

FIG. 7 shows a graph of cell temperature after a thermal runaway is initiated in various different battery configurations.

### DETAILED DESCRIPTION

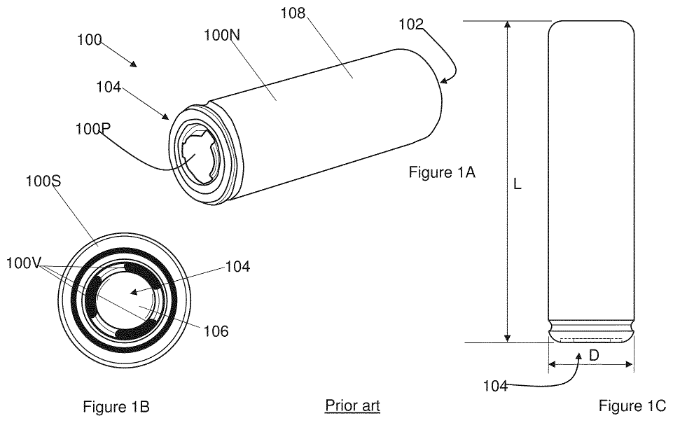

FIGS. 1A-C show different views of a conventional cylindrical cell 100. Cylindrical cells 100 are widely available in a variety of different sizes. For example, in traction batteries for vehicles, cells having a diameter D of 21 mm and a length L of 70 mm are often used. Such cells are typically referred to as 21700 cells (the first two numbers referring to the diameter D, in mm, and the last three numbers referring to the length L, in tenths of mm). However, it will be understood that other sizes of cell may also be used in embodiments of the present invention.

As will be well understood by the skilled person, the cell 100 comprises a positive terminal 100P, a negative terminal 100N, and vent means 100V. The positive terminal is provided by a steel end cap 106 in a central region of the first end 104 of the cell, and the negative terminal is provided by a steel cylindrical case 108. The steel cylindrical case 108 covers the second end 102, the entire cylindrical surface between the first and second ends, and a peripheral region 100S of the first end surface. The peripheral region of the first end surface may also be referred to as a “shoulder” region 100S of the first end surface 104. In commercially-available cells, it is sometimes the case that the end cap that defines the positive terminal 100P on the first end surface 104 protrudes beyond the shoulder region of the first end surface, although this is not the case in the cell shown in FIG. 1. This allows a substantially planar connector to be connected to the positive terminal and not the negative terminal. As will be well understood by the skilled person, it is important to avoid direct electrical connections between the positive and negative terminals, as such connections create a short circuit which may damage the cell.

As shown in FIG. 1, the cell 100 comprises three vent means 100V in the first end surface 104, between the steel end cap 106 that defines the positive terminal 100P and the shoulder region 100S of the steel cylindrical case 108. The vent means 100V are gaps that are covered by a material that will rupture to allow hot gases to escape through the gaps between the end cap 106 and steel cylindrical case 108 in the event of excessive pressure occurring inside the cell, thereby mitigate against the risk of the cell exploding.

Cells 100 may be grouped together within a housing and electrically connected together by a busbar assembly to create a battery module. Furthermore, as will become apparent from the following description, in some embodiments a plurality of cells 100 may be mechanically joined together to form a group of cells, and a battery module may comprise one or more of such groups of cells.

As will be well understood by the skilled person, abnormal operation of cells in a battery module can lead to the cell undergoing “thermal runaway”, which is a self-sustaining exothermal reaction which emits a large volume of gas and debris, and that will typically continue until all of the available fuel within the cell has been consumed by the reaction. However, cell venting means are typically designed to allow hot gases to escape when the temperature and pressure has reached a level which is not necessarily sufficient to initiate thermal runaway. Venting when the conditions within the cell are not yet sufficiently extreme to cause thermal runaway can prevent an abnormal operating condition from progressing into thermal runaway. Accordingly, abnormal operating conditions within cells that lead to venting events may be categorised into those that do and do not ultimately lead to thermal runaway. However, it is generally necessary to design battery modules, in particular traction battery modules, which may comprise hundreds or even thousands of such cylindrical cells, to be able to withstand a cell undergoing thermal runaway. This also ensures that the battery module is able to withstand less severe cell malfunctions that do not lead to thermal runaway.

Vehicle battery modules often comprise a plurality of cylindrical cells 100 of the type shown in FIG. 1, each having a positive terminal 100P and a negative terminal 100N. The cells are typically located within a housing, and a busbar is provided to connect the cells together in a configuration that provides the required voltage and charge capacity. Should one of the cells in a battery module undergo an abnormal operating condition, such as thermal runaway, it is important that the heat generated by the cell does not cause damage to the other cells. In extreme cases, such damage could lead to a cascade of thermal runaway events ultimately affecting all of the cells in a battery module.

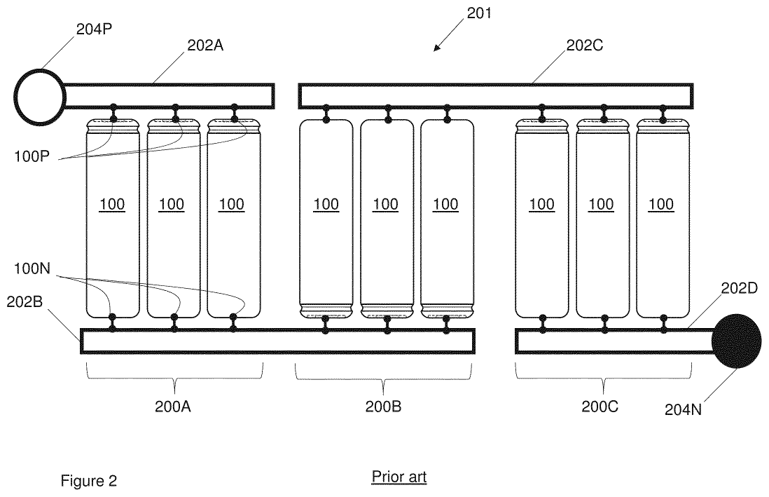

FIG. 2 shows an example configuration of cylindrical cells within a vehicle battery module 201, the module 201 would typically be located within a housing (not shown). Cells 100 are grouped together into a plurality of groups, or “bricks” 200A-C. Although only three bricks are shown in FIG. 2, it will be understood that significantly more may be provided, depending upon the required voltage and the voltages of the individual cells. Each brick 200A-C comprises a plurality of cells 100 in a side-to-side configuration. The orientation of the bricks alternates between adjacent bricks. In the example shown in FIG. 2, the positive terminals of cells in the end bricks 200A, 200C face upwards, and the positive terminals of the cells in the middle brick 200B face downwards. The electrical connections between cells are arranged such that the cells within a given brick are all connected to one another in parallel, and each brick is connected in series to at least one other brick.

The electrical connections are provided by a busbar, which is in four separate components 202A-D in the example illustrated in FIG. 2. The first busbar component 202A connects the positive terminals of all of the cells in the first group 200A together. The second busbar component 202B connects all of the negative terminals of the cells in first group 200A and all of the positive terminals of the cells in the second group 200B. The third busbar component 202C connects all of the negative terminals of the cells in the second group 200B and all of the positive terminals of the cells in the third group 200C. The fourth busbar component 202D connects all of the negative terminals of the cells in the third group 200C.

A positive terminal 204P of the battery module 201 is connected to the first busbar component 202A, and a negative terminal 204N of the battery module is connected to fourth busbar component 202D. As will be well understood by the skilled person, the arrangement shown in FIG. 2 provides parallel connections between each of the cells within a given group 200A, 200B, 200C, and series connections between adjacent groups.

Although not shown in FIG. 2, the configuration of cells shown in FIG. 2 typically requires cooling means to be provided in the space between adjacent cells. Although it is possible to cool either end of the cells, this is complicated by the presence of busbars at both ends of the cells. However, the provision of cooling means between adjacent cells reduces the efficiency with which cells can be packaged into a battery module, thereby reducing the maximum charge and current density that can be achieved with a given type of cell in a given package volume. Furthermore, alternating the orientation of the bricks 200A-C means that the vent features in adjacent bricks are pointing in opposite directions, so protection against venting gases must be provided at either end of the battery module. Since it is often the case that at least part of the battery module is located underneath the floor of the vehicle body, it is particularly important to provide protection against venting gases in the top portion of the battery module, so that the venting gases cannot enter an occupant compartment of the vehicle.

Each of the individual cells in the bricks 200A-C is spaced apart from each of the other cells. This allows the cylindrical surfaces of the cells to be cooled, for example by passing cooling channels (not shown) between the cells. However, as discussed above, the need to space the cells apart sufficiently to allow space for cooling channels clearly reduces the efficiency with which the cells may be packed into a given volume, thereby reducing the peak current and energy storage that can be achieved by a battery module of a given volume.

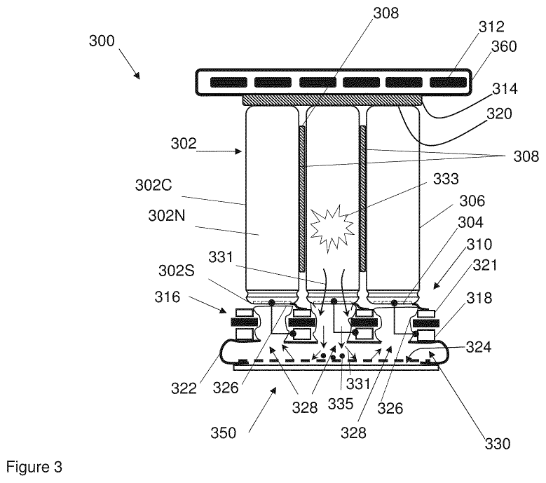

FIG. 3 shows a cross section through a battery module 300 in an embodiment of the present invention. Battery module 300 comprises a plurality of cells 302 in a substantially vertical orientation with their first ends 310 facing downwards and the second ends 320 facing upwards. The cells 302 are in a side-to-side arrangement, with each cell 302 being joined to the neighbouring cells by a thin layer of adhesive 308.

In the illustrated embodiment the cells are 21700 cells as described above with respect to FIG. 1, although it will be understood that the present invention is applicable to any type of cylindrical cell. Each cell has a positive terminal 304 located in a central region of the first end surface 310 and a negative terminal 306, which is the cell casing. The negative terminal 302N therefore covers the second end 320, the cylindrical surface 302C between the first and second ends 310, 320, and the peripheral, or shoulder, region 302S of the first end, as shown in FIG. 3.

The second ends 320 of each of the cells 302 are in contact with a cooling plate 360 via a layer of thermal interface material 314. The cooling plate 360 comprises a plurality of enclosed channels 312 through which coolant can flow. Accordingly, the temperature of the cells 302 can be managed by cooling the second ends 320 of all of the cells 302.

A single-sided busbar 316 is provided adjacent to the first ends 310 of the cells 302. Although various configurations of single-sided busbar are possible, in the illustrated embodiment the busbar 316 comprises a positive collection plate 318 having a plurality of tabs connected to the positive terminals 304 of each of the cells 302, and a negative collection plate 321 contacting the negative terminals 302N of each of the cells at the peripheral region 302S of the first end. Although the cells 302 shown in FIG. 3 are all connected in parallel by the busbar 316, it will be understood that other battery modules may comprise a plurality of groups of cells, wherein the cells within each group are connected in parallel, and each group of cells is connected in series with one or more other groups of cells. In the illustrated embodiment, series connections can be achieved by connecting a negative collection plate connected to one group of cells to a positive collection plate that is connected to an adjacent group of cells.

The cells 302 and busbar 316 are disposed within a housing 350, of which only a lower surface 324 is visible in FIG. 3, although the cooling plate 360 may also form the top surface of the housing 350 in some embodiments. In some embodiments, the lower surface 324 of the housing may also form a bash plate located on an underside of the vehicle in which the battery module 300 is installed. The cells 302 and busbar 316 are spaced apart from the lower surface 324 of the housing by a support component 322. Provision of the support component 322 between the lower surface 324 of the housing and the cells 302 ensures that a sizable and substantially empty vent volume 330 is provided inside the housing into which gases 331 from a venting cell undergoing a venting event 333 may pass into safely, directing vent gasses 331 away from neighbouring cells. Advantageously, provision of such a vent volume 330 allows vent gases 331 and debris 335 to cool, without heating or otherwise affecting neighbouring cells.

As can be seen from FIG. 3, the support component comprises a plurality of apertures 328, each aperture being proximate the first end of a respective one of the cells 302. A protective layer 326 is provided in each of the apertures, the protective layer being attached to the edge of the opening and substantially covering the first end of the respective cell 302. Accordingly, the combination of the support component 322 and the protective layers 326 may be referred to as a “cover”.

The protective layer 326 is arranged to break when a predetermined pressure differential exists across the protective layer 326. The predetermined pressure differential is selected to ensure that the protective layer associated with a given cell is broken when the cell undergoes a venting event, thereby allowing the vent gases to escape into the vent volume 330. However, when a cell undergoes a venting event, the intact protective layers on the neighbouring cells do not break, because the pressure within the vent volume 330 is not increased sufficiently to break the protective layers on the non-venting cells.

When the gases from a venting cell 302 enter the vent volume 330, they initially impinge on the lower inside surface 324 of the housing, which may form part of a bash plate on the underside of the vehicle in which the battery module 300 is installed. This causes the vent gases to be cooled, as the bash plate has a significant thermal mass, and is cooled by air passing underneath the vehicle. Furthermore, the vent gases are also cooled by mixing with the air or other gasses in the vent volume 330. In the illustrated embodiment, the support component 322 holds the cells 302 and busbar 316 above the bash plate, so that the depth of the vent volume 330 is approximately 6.6 mm. In a typical housing containing approximately 660 cells in a single layer the lower inside surface 324 may have an area of approximately 300,000 mm², a spacing of 6.6 mm between the support component 322 the lower surface 324 may provide a vent volume of approximately 2,000,000 mm³, which provides sufficient volume for the vent gases to cool and disperse without significantly increasing the temperature of the cells that are not venting.

It will be understood that in other embodiments the depth of the vent volume 330 may be different. For example, in some embodiments the depth of the vent volume 330 may be between 1 mm and 20 mm, preferably between 3 and 10 mm or between 4 and 8 mm. Similarly, the depth of the vent volume may be defined in terms of a fraction of the individual cell diameter, for example the depth of the vent volume may be between 1/10-1/1 of the cell diameter, preferably ⅙-¾ of the cell diameter and more preferably ⅕-½ of the cylindrical cell diameter. In the case of the example shown, the venting volume depth is approximately ⅓ of the cell diameter. Other vent volume depths are useful.

Although not visible in FIG. 3, the housing comprises at least one exhaust port in a portion of the housing that forms a boundary of the venting volume. The exhaust port allows fluid communication between the vent volume and the exterior of the housing, thereby allowing vent gases to escape from the vent volume 330, and avoiding an excessive increase in pressure within the vent volume after a venting event. This helps to ensure that if one cell undergoes a venting event, the hot gases ejected from the cell do not cause damage to other cells that could otherwise lead to a cascade of venting events.

It will be understood that the support component 322 in combination with the protective layers 326 act to separate the vent volume 330 from the cells 302 and the volume surrounding the cells 302. As such, the combination of the support component 322 and the protective layers 326 may be referred to as a separation structure.

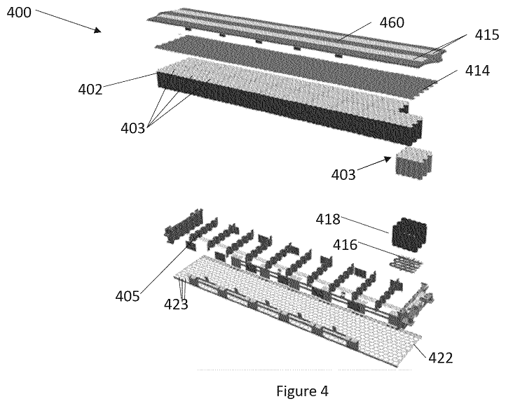

FIG. 4 shows an exploded view of a battery module 400 in another embodiment of the present invention. Battery module 400 comprises a plurality of cylindrical cells 402 arranged into two rows of eleven cell groups 403, so that 22 cell groups are provided in total. The cylindrical cells may be 21700 cells as described in FIG. 1, and they are all arranged with their positive terminals and vent means directed downwards. In some embodiments, the battery module 400 may be installed within a vehicle in substantially the orientation shown in FIG. 4, with at least a portion of the vehicle body being located above the battery module. For example, an occupant compartment and/or a luggage compartment of the vehicle may be located above the battery module. Additionally or alternatively, depending on the type of vehicle application for which the battery module is intended, the battery module 400 may be installed below a load-carrying area of the vehicle, such as a bed in the case the vehicle is a pick-up truck, or a cargo area in the case the vehicle is a commercial vehicle such as a van.

The cells in each cell group 403 are joined together using an adhesive having a thickness of 0.5 mm or less prior to assembly of the battery module. In the illustrated embodiment, the thickness of the adhesive is approximately 0.3 mm. A cell carrier component 405 is provided to locate each cell group within the housing (not shown), and to provide the required spacing between adjacent cell group 403. The cell carrier component 405 may also locate at least part of the single-sided busbar 416, of which only a portion is visible in FIG. 4.

Each cell group 403 is wrapped with an electrically-insulating material 418, to ensure that unwanted electrical connections between the negative terminals of cells in adjacent groups do not occur.

Cooling of the cells is provided by cooling plate 460, which is in contact with the second ends of the cells (i.e. the end of the cells opposite the positive terminal) via a layer of thermal interface material 414. The cooling plate 460 comprises a plurality of channels through which a liquid coolant may flow, thereby cooling the cells 402.

In some embodiments, the cooling plate 460 provides an upper surface of the housing. Structural members 415 may be provided to ensure that the cooling plate 460 has the required stiffness to form part of the housing.

A support component 422 is provided to support the battery module within the housing. The support component 422 comprises a plurality of apertures 423, each aperture being positioned so as to be aligned with and adjacent to the first end a respective cell 402 in the assembled battery module 400, so as to allow gases to pass through the support component 422 should a cell undergo a venting event.

Although the housing is not visible in FIG. 4, it will be understood that the support component 422 is configured to maintain a predetermined spacing between the cells 402 and the lower inside surface of the housing, such that a vent volume is provided underneath the cells. An exhaust port is also provided in the housing to allow gases to escape from the vent volume.

As discussed above with respect to FIG. 3, the vent volume provides a volume in which vent gases can expand and cool, thereby reducing the risk that a venting event in an individual cell will damage other cells and potentially cause them to also undergo venting events. Further cooling of the vent gases and any debris emitted from a venting cell may be provided when the gases and debris impinge on the lower inside surface of the housing, which will typically have a significant thermal mass. In embodiments where the lower surface of the housing also provides at least part of a bash plate on an underside of the vehicle in which the battery module is installed, the lower surface of the housing will also be cooled by air passing underneath the vehicle, thereby enhancing the ability of the lower surface of the housing to cool vent gases and debris.

Although not visible in FIG. 4, it will be understood that in some embodiments the assembled battery module 400 may also include one or more protective layers associated with each of the cells 403 located in each of the apertures 423 in the support component 422. The protective layers may serve a similar purpose to the protective layers 326 described above with respect to FIG. 3. That is, the protective layers may be arranged to rupture when the cell they are attached to undergoes a venting event, but remain intact when a neighbouring cell undergoes a venting event. In this way the protective layers may prevent vent gases from entering the space between the cells 402. Again, the combination of the support component 422 and the protective layers may be referred to as a separation structure, as these components separate the vent volume from the volume surrounding the cells. The protective layers may comprise one or more layers of an electrically insulating material such as mica or a mica-based material sheet or film. Other electrically insulating materials are useful.

In an alternative embodiment, a filter layer may be provided adjacent to the support component 422. Such a filter layer may be arranged such that it does not provide a significant restriction to high-pressure vent gases as they are ejected from a venting cell, thereby allowing the vent gases to enter the vent volume between the cells and the lower inside surface of the housing. However, once the vent gases have expanded and cooled within the vent volume, the pressure within the vent volume may no longer be sufficient to cause a significant amount of the vent gases to pass back across the filter layer. In this way, the filter layer may reduce or substantially prevent the flow of vent gases into the space between the cells 402. The filter layer may be a mesh, or any other suitable layer that will not undergo adverse reactions when exposed to high temperature vent gases. The filter layer may advantageously be arranged to dissipate the localised heat from a venting cell, further mitigating the potential for damage to neighbouring cells. In such embodiments, the combination of the filter later and the support component 422 may be referred to as a separation structure. In an example, the filter layer may comprise a steel mesh.

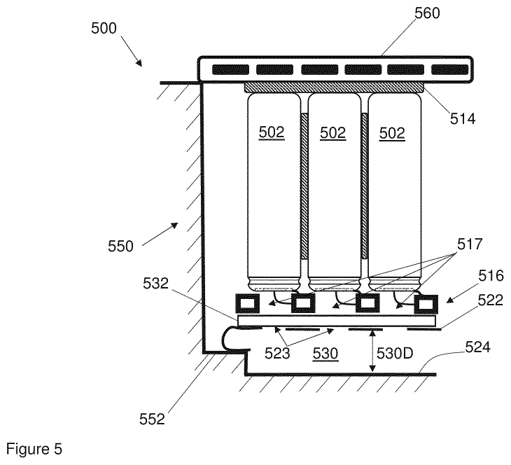

FIG. 5 shows a partial cross sectional view through a battery module 500 in another embodiment of the present invention, which is located within a housing 550. Battery module 500 comprises a plurality of cylindrical cells 502, of which only three are shown in FIG. 5. The cells may be 21700 cells as described above with respect to FIG. 1, although it will be understood that other types of cylindrical cells are equally applicable.

The cells 502 are all cooled at their second end (i.e. the end opposite the positive terminal) by a cooling plate 560, which has one or more enclosed channels therein through which a liquid coolant can flow. A layer of thermal interface material 514 is provided between each of the cells and the cooling plate 560. As will be well understood by the skilled person, the thermal interface material provides an improved thermal connection between the cells 502 and the cooling plate 560, and may also help to mechanically secure the cells to the cooling plate 560.

A single-sided busbar 516 is provided adjacent to the first ends of the cells 502, and a filter layer 532 which covers the first ends of the cells is provided adjacent to the busbar 516. As will be discussed in more detail below, the filter layer 532 is arranged to reduce or substantially prevent the flow of hot gases from a venting cell into the space between the cells 502.

The filter layer 532, the cells 502 and the busbar 516 are all supported within the housing 550 on a support component 522, which ensures that a gap is provided between the filter layer 532 and the lower inside surface 524 of the housing 550. The outside edges of the support component rest on a ledge 552 defined by the inner surface of the housing 550.

The support component 522 is provided with apertures 523 substantially coincident with the first ends of each of the cells 502, which apertures allow vent gases expelled from the cells to pass into the vent volume 530.

As discussed above with respect to FIGS. 3 and 4, the vent volume 530 provides a space in which hot vent gases expelled from a cell undergoing runaway venting event may expand and cool. An exhaust port is provided in the housing 550 to allow gases from the vent volume to escape from the housing, thereby preventing an excessive build up of pressure within the vent volume 530. Furthermore, the lower surface 524 of the housing 550 may comprise at least part of a bash plate on the underside of the vehicle in which the battery module is installed. As such, the lower surface of the housing may be formed from a sheet of metal having a thickness of between 1-3 mm, and will therefore have a significant thermal mass. Other material thicknesses are useful and will depend on the material chosen for the housing. In the example shown, the housing is formed at least in part from steel. Vent gases entering the vent volume 530 will therefore be cooled to a significant extend when they impinge on the lower inside surface 524 of the housing. The lower surface of the housing may be cooled by air underneath the vehicle, thereby maintaining the cooling effect provided by the lower surface of the housing throughout a cell venting event.

To provide an adequate volume for venting gases to expand and cool, the vent volume 530 may comprise a void having a depth 530D of at least 1 mm, for example of about 1-20 mm. In specific embodiments, the void may have a depth of 3-10 mm or 4-8 mm. In a particular embodiment, the void has a depth of 6.6 mm. Advantageously, such a depth provides adequate volume for the vent gases to expand and cool, whilst making efficient use of the available space. It will be understood that in the present context, the depth of the void refers to dimension along an axis parallel to the longitudinal axes of the cells 502.

The filter layer 532 comprises a mesh that is arranged to allow the high pressure and high velocity vent gases exiting one of the cells to pass through the mesh into the vent volume 530. However, the mesh provides a barrier to the vent gases that are in the vent volume 530, as the pressure within the vent volume is substantially less than that near the vent means of a venting cell. Accordingly, the filter layer provides protection against hot vent gases passing from the vent volume into the volume surrounding the cells 502.

A further beneficial effect of the filter layer 532 is that it helps dissipate the heat of the vent gasses, which cool as they pass through the filter layer. The filter layer may be produced from a metal having a significant thermal mass, so as to potentially provide a significant cooling effect to vent gases exiting a venting cell. In some embodiments, the cooling effect produced by the filter layer may be further enhanced by including a phase change material within the filter layer. For example, the phase change material may be coated onto a metallic mesh. Such a phase change material may be arranged to undergo a phase change when heated by vent gases, thereby absorbing heat from the vent gases without increasing the temperature of the filter layer.

The thermal mass of the support component 522 may also contribute significantly to the cooling of any vent gases. For example, the support component 522 may be made from sheet steel having a thickness of 0.5-2 mm, preferably around 1 mm.

It will be understood that the support component 522 and the filter layer 532 may be referred to together as a “separation structure”. However, in some embodiments, the filter layer 532 may be omitted or may be formed as a single unitary part with the support component 522. In such embodiments, the support component 522 alone may be referred to as the separation structure.

In an alternative embodiment to that described above with respect to FIG. 5, the filter layer 532 may be replaced with a layer of non-combustible insulating material that is arranged to rupture when a cell undergoes a venting event. For example, the layer of insulating material may comprise a layer of mica or SLENTEX®, optionally with weakened portions to reduce the pressure required to break the layer after a venting event. In embodiments where the filter layer 532 is replaced with a layer of non-combustible insulating material, the spaces 517 between the first ends of the cells 502 and the layer of non-combustible insulating material are preferably filled with a non-solid or otherwise non-curing compound, which may be a non-curing silicone-based compound, preferably a non-curing intumescent compound. The other features shown in FIG. 5 may remain substantially unchanged.

Advantageously, filling the spaces 517 with a non-curing compound allows vent gases to escape from a venting cell, because the compound is ejected into the vent space 530 when the layer of insulating material breaks, but the compound prevents vent gases from entering the spaces between the cells 502, because there is little space available for the compound to be displaced into by vent gases that have entered the vent volume 530. Accordingly, an intumescent compound may provide particularly effective protection against hot vent gases in the vent volume 530 entering the space between the cells.

In some embodiments, a gap could be provided between each of the cells 502. In such embodiments, it will be understood that the cooling plate 560 at the second end of the cells may be dispensed with, and instead cooling means may be provided in contact with the cylindrical surfaces of the cells. However, it also will be understood that in the embodiment shown in FIG. 5 the gap between the cells is not essential, and that in some embodiments the cells may directly contact one another, or they may be joined by an adhesive in a similar manner to the cells shown in FIGS. 3 and 4.

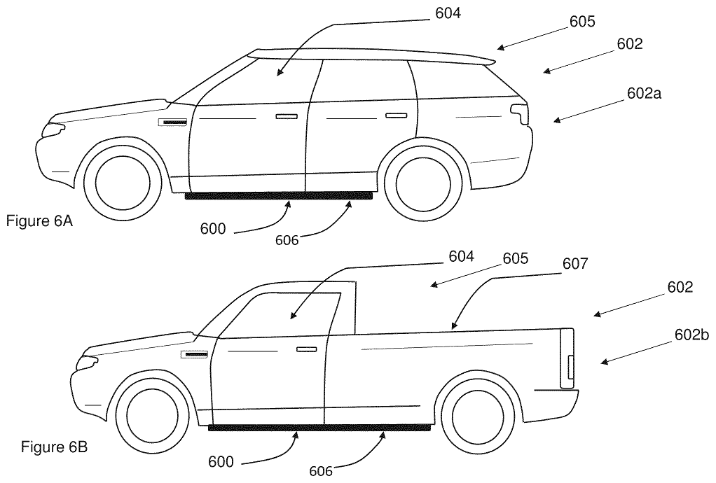

A particular advantage of the above embodiments is that all of the cells within the battery module are oriented in the same direction. Accordingly, whenever one of the cells undergoes a venting event, the vent gases are ejected in the same direction. This is advantageous because it allows reinforcement of the housing to prevent vent gases from escaping on only one side of the housing. Furthermore, as illustrated in FIG. 6, it is conventional for electric or hybrid vehicles 602 to locate the battery module 600 at least partially underneath a body 605 of a vehicle. The body 605 may comprise an occupant compartment 604 as shown in FIG. 6a depicting a typical passenger car such as a SUV 602a. The vehicle body 605 may further comprise a cargo area 607 such as a truck bed as shown in FIG. 6B which depicts a typical commercial vehicles such as a pick-up truck 602b.

Accordingly, in several embodiments of the present invention, a battery module (which may be a battery module 300, 400, 500 as illustrated above with respect to FIGS. 3-5) may be located within a vehicle 600 with the first ends of the cells facing downwards. In this way, it is ensured that high pressure and high velocity vent gases exiting a malfunctioning cell are directed away from the occupants and/or cargo of the vehicle.

In the embodiment illustrated in FIG. 6, the battery module is located at the bottom of the vehicle, such that the lower surface of the housing of the battery module also forms a bottom surface of the vehicle, which may be referred to as a “bash plate” 606. Advantageously, the bash plate 606 has a significant thermal mass, so in the event of a cell venting the bash plate is capable of absorbing a significant amount of energy from the hot gases. Furthermore, the bash plate is cooled by ambient air passing underneath the vehicle, which increases the amount of energy that can be absorbed by the bash plate from any hot vent gases that impinge on the bash plate.

Although the present invention has been described with respect to embodiments in which the cell vent means are directed downwards in use, it will be understood that alternative orientations are also possible. For example, the arrangements shown in FIGS. 3-5 could be inverted such that the vent means are directed upwards, or rotated through 90 degrees such that the longitudinal axes of the cells are horizontal. In such embodiments, the “support component” 323, 423, 523 may no longer bear any of the weight of the cells. However, an analogous component may still be provided as part of a separation structure, to separate the vent volume from the volume surrounding the cells.

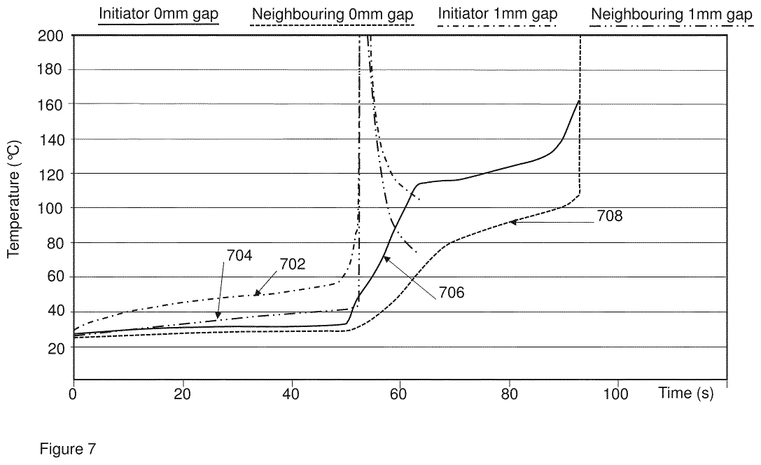

In several of the above embodiments, the cells are within a cell group that are connected in parallel are directly joined together by a layer of adhesive. Such an adhesive layer will typically have a thickness 0.5 mm or less, preferably 0.3 mm or less and will effectively establish direct thermal contact between adjacent cells. It has hitherto been assumed that direct thermal contact between cells within a battery module is undesirable. However, as illustrated by FIG. 7, the present inventors have recognised that this is not necessarily the case.

FIG. 7 shows the temperature changes over time experienced by cells within different battery modules after a thermal runaway event is deliberately initiated in one of the cells in the battery module. In all cases, the initiation of the thermal runaway event is caused by rupturing the cylindrical surface of one of the cells using a steel penetrator, and occurs at time zero.

Line 702 illustrates the temperature of a cell in which a thermal runaway event is initiated by rupturing the cylindrical surface of the cell, in a battery module in which the cells are spaced apart by 1 mm air gaps. Line 704 illustrates the temperature within a cell adjacent to the cell whose temperature is illustrated by line 702. For both of the cells illustrated by lines 702 and 704, a rapid temperature increase is observed approximately 50-55 seconds after the rupture of the casing. The rapid increase in temperature may be considered to be the start of thermal runaway.

Line 706 illustrates the temperature of a cell in which a thermal runaway event is initiated by rupturing the cylindrical surface of the cell, the cell being within another battery module in which adjacent cells are in direct thermal contact with one another. Line 708 illustrates the temperature of a cell adjacent to the cell whose temperature is illustrated by line 706. As can be seen from FIG. 7, both cells experience a temperature increase after approximately 50-55 seconds, but this temperature increase is much less rapid than the temperature increases experienced by the cells in the battery module where cells are spaced apart by 1 mm, and a plateau is reached at approximately 65-70 seconds. A second, more rapid, temperature increase then occurs at approximately 90-95 seconds, and this temperature increase may be considered to be the start of thermal runaway. Accordingly, FIG. 7 shows that the delay before the onset of thermal runaway was 40 seconds longer for the battery module in which cells are directly touching as compared to the battery module in which the cells are spaced apart by 1 mm. It is hypothesised that this increase in the delay before the onset of thermal runaway occurs because the cells that are in contact with the cell in which thermal runaway is initiated all act as heat sinks, thereby slowing the heating of all of the cells.

Slowing of the initiation of thermal runaway is advantageous for various reasons. It is of course essential to ensure that, after damage to a vehicle battery module, any adverse reactions that take place within the battery module occur slowly enough to allow the vehicle occupants time to vacate the vehicle. Indeed, in some jurisdictions it is a legislative requirement for the vehicle to provide the occupants at least five minutes to exit and clear the vehicle after the battery module is damaged. Furthermore, delaying of the onset of thermal runaway may allow actions to be taken that mitigate or substantially prevent the eventual onset of thermal runaway. For example, the relatively slow temperature increase that occurs between approximately 50-55 seconds and approximately 90-95 seconds in the cells that directly contact one another may allow the battery management system to recognise that an abnormal operating condition has occurred before thermal runaway takes place, and therefore allow appropriate corrective action to be taken. Such action may include opening the high voltage circuit, increasing the flow rate of coolant to the battery module, and providing a warning to the occupants of the vehicle that the battery module has been damaged and they should urgently stop and vacate the vehicle.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A battery module comprising:
a housing;
a plurality of cylindrical cells, each of the cylindrical cells having a first end and a second end, wherein vent means is located at the first end of each of the cylindrical cells; and
a separation structure;
wherein:
the plurality of cylindrical cells are disposed within the housing in a common orientation such that the first ends of the cylindrical cells are substantially coplanar;
the separation structure is arranged within the housing proximate to the first ends of the plurality of cylindrical cells and is arranged to allow gases expelled from a venting cell to pass through the separation structure; and
the housing comprises a vent volume arranged between the separation structure and an inner surface of the housing for allowing venting from the vent means of each of the plurality of cylindrical cells into the vent volume via the separation structure.

2. The battery module as claimed in claim 1, wherein each of the cylindrical cells circumferentially abuts at least two other cylindrical cells.

3. The battery module as claimed in claim 1,
comprising a busbar arranged at the first end of the plurality of cylindrical cells and electrically connected to the first ends of the cylindrical cells.

4. The battery module as claimed in claim 1,
wherein the separation structure comprises a support component having a plurality of apertures formed therein and a protective layer covering each of the apertures, the protective layer being arranged to break when a predetermined pressure differential exists across the protective layer.

5. The battery module as claimed in claim 4, wherein the protective layer comprises a coating applied to a surface of the first end of each cylindrical cell.

6. The battery module as claimed in claim 4, wherein the protective layer comprises a sheet of insulating material.

7. The battery module as claimed in claim 1, wherein the separation structure comprises a first filter layer.

8. The battery module as claimed in claim 7, wherein the first filter layer is arranged to:
allow venting from the vent means of each of the plurality of cylindrical cells into the vent volume; and
substantially prevent material vented from the vent means of one of the plurality of cylindrical cells to traverse the first filter layer from the vent volume to another of the plurality of cylindrical cells.

9. The battery module as claimed in claim 7, and further comprising a second filter layer adjacent to the first filter layer.

10. The battery module as claimed in claim 7, wherein the first filter layer includes a phase change material.

11. The battery module as claimed in claim 1, wherein the housing further comprises an exhaust port configured to allow fluid in the vent volume to exit the housing.

12. The battery module as claimed in claim 1, wherein the vent volume is a void.

13. The battery module as claimed in claim 1, comprising a cooling plate arranged to be thermally coupled to the second end of each of the plurality of cylindrical cells.

14. The battery module as claimed in claim 1, wherein the housing comprises a bash plate arranged to form an exterior of the battery module, wherein the inner surface of the housing is at least partly formed by the bash plate and wherein the bash plate is arranged to form an underside of the housing.

15. A vehicle comprising the battery module as claimed in claim 1.

16. The battery module as claimed in claim 3, wherein the busbar is located between the first ends of the cylindrical cells and the separation structure.

17. The battery module as claimed in claim 6, wherein a non-solid compound is provided in a space between the first ends of at least some of the cylindrical cells and the sheet of insulating material.

18. The battery module as claimed in claim 7, wherein the first filter layer comprises a mesh.

19. The battery module as claimed in claim 9, wherein the second filter layer includes a phase change material.
